(19) United States
(12) Patent Application Publication
(10) Pub. No.: US 2013/0266034 A1
(43) Pub. Date: Oct. 10, 2013

(54) METHODS AND APPARATUSES FOR ENGINEERING ELECTROMAGNETIC RADIATION

(71) Applicants: Nanfang Yu, Cambridge, MA (US); Federico Capasso, Cambridge, MA (US)

(72) Inventors: Nanfang Yu, Cambridge, MA (US); Federico Capasso, Cambridge, MA (US)

(73) Assignee: President and Fellows of Harvard College, Cambridge, MA (US)

(21) Appl. No.: 13/696,734

(22) PCT Filed: May 6, 2011
(86) PCT No.: PCT/US11/35588

§ 371 Date: Jan. 28, 2013

Related U.S. Application Data
(60) Provisional application No. 61/332,363, filed on May 7, 2010.
(60) Provisional application No. 61/371,330, filed on Aug. 6, 2010.

(51) Int. Cl. H01S 3/063

(52) U.S. Cl. CPC H01S 3/063
USPC 372/27

(57) ABSTRACT

laser devices described may emit a beam of electromagnetic radiation having a large wavelength (e.g., mid-infrared, far-infrared) and exhibiting a low angle of divergence. In some embodiments, the wavelength of the electromagnetic radiation is between 3 microns and 500 microns and the divergence angel is less than 15 degrees. Electromagnetic waves may be produced from a single monolithic laser device which includes a laser waveguide (e.g., quantum cascade laser waveguide) and a collimating element having at least one indented region (e.g., a plurality of periodically disposed grooved structures). A portion of the electromagnetic radiation may propagate as surface waves (e.g., surface plasmons) along the surface of the collimating element where indented regions in the collimating element may decrease the propagation velocity of the surface waves. A portion of the electromagnetic radiation may also be substantially convinced within a grooved structure of the collimating element (e.g., as channel polaritons).

### RELATED APPLICATION

This application claims priority to U.S. Provisional Application No. 61/332,363 filed May 7, 2010, entitled “Methods and Apparatus for Engineering Wavefronts.”

### FEDERALLY SPONSORED RESEARCH

Research leading to various aspects of embodiments presented herein were sponsored, at least in part, by the following government grant: AFOSR, Grant No. FA9550-09-0505-DOD. The United States Government may have certain rights in the invention.

### BACKGROUND

There has been increasing interest in lasers that emit electromagnetic radiation in the mid-infrared to far-infrared wavelength ranges, particularly for applications in areas such as medical diagnostics, detection and sensing of chemicals, and imaging.

Quantum Cascade Lasers (QCLs) are unipolar lasers that utilize optical transitions between confined electronic sub-bands (e.g., conduction bands) of semiconductor heterostructures. In a QCL, electrons are able to stream down a series of energy potential steps provided by coupled quantum wells via controlled tunneling where photons are sequentially emitted at each potential step. Based on the degree of quantum confinement, QCLs may emit electromagnetic radiation in the mid-infrared or far-infrared wavelength range. The emitted photon energy is determined by the thicknesses of the wells and barriers and can be tailored by bandgap engineering. Reliable operation of QCLs in the 3-24 micron wavelength range has been achieved, which covers the so-called molecular fingerprint region of the optical spectrum. In this wavelength range, molecules have unique and strong rotational-vibrational absorption features that allow for their identification.

For lasers that emit electromagnetic radiation that generally exhibits a high degree of divergence angle (e.g., laser diodes), an optical lens is often used as a collimator to collimate the radiation into rays that are nearly parallel. Accordingly, upon propagation of a collimated beam of electromagnetic radiation, divergence angle of the beam is lessened.

### SUMMARY

Systems and methods for engineering electromagnetic radiation, including those suitable for use in lasers such as quantum cascade lasers, are described herein.

Embodiments described relate to a laser device having a collimating element that includes at least one indented region. The collimating element may be disposed adjacent to a laser waveguide on the laser device. In some embodiments, the collimating element and the laser waveguide may both be formed as part of the same laser device. For example, a laser waveguide may be formed on a semiconductor or metallic substrate and a collimating element having at least one indented region may be formed on the same substrate. Accordingly, the laser waveguide and the collimating element may be fabricated together resulting in a single monolith device. In some embodiments, the collimating element includes a plurality of indented regions formed as grooved structures that couple a portion of the electromagnetic radiation emitted from the laser waveguide to surface waves (e.g., in the form of surface plasmons) traveling along a surface of the collimating element and scatter energy of the surface waves into the far field to form a collimated beam. Upon emission of a beam of electromagnetic radiation from the laser waveguide, grooved structures may serve to decrease the velocity of surface waves and may also function to substantially confine a portion of the radiation to the grooved structures themselves. The laser waveguide may be configured to emit electromagnetic radiation having a mid-infrared wavelength and/or having a far-infrared wavelength.

The laser waveguide may emit a beam of electromagnetic radiation having a mid-infrared or a far-infrared wavelength where the electromagnetic radiation also exhibits low divergence angle. In some embodiments, the electromagnetic radiation may have a wavelength of between about 3 microns and about 500 microns and exhibit a divergence angle of less than 15 degrees.

In an illustrative embodiment, a laser device is provided. The laser device includes a substrate; a laser waveguide disposed on the substrate and configured to emit electromagnetic radiation; and a collimating element disposed adjacent to the laser waveguide and having at least one indented region.

In another illustrative embodiment, a method of operating a laser is provided. The method includes emitting a beam of electromagnetic radiation from a laser waveguide having a wavelength of between about 3 microns and about 500 microns and the beam of electromagnetic radiation exhibiting a divergence angle of less than 15 degrees, wherein a collimating element is attached to the laser waveguide.

In a different illustrative embodiment, a method of using a laser device to collimate electromagnetic radiation is provided. The method includes operating a laser waveguide disposed adjacent to a collimating element to emit electromagnetic radiation from the laser waveguide such that a portion of the radiation propagates along a surface of the collimating element and is scattered into free space to form a collimated beam that exhibits a divergence angle of less than 15 degrees.

In yet another illustrative embodiment, a method of manufacturing a laser device is provided. The method includes forming a laser waveguide on a substrate; and forming on the substrate a collimating element comprising at least one indented region adjacent to the laser waveguide.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing within this disclosure are contemplated as being part of the inventive subject matter disclosed herein. It should also be appreciated that terminology explicitly employed herein that also may appear in any disclosure incorporated by reference or otherwise referenced herein should be accorded a meaning most consistent with the particular concepts disclosed herein.

Other aspects, embodiments, advantages and features of the invention will become apparent from the following detailed description.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a perspective view of a light emitting device in accordance with an illustrative embodiment;

FIG. 1B is a side view of the light emitting device of FIG. 1A;

FIG. 2A is a perspective view of a collimating element in accordance with an illustrative embodiment;

FIG. 2B is a side view of the collimating element of FIG. 2A with a surface wave propagating along a surface;

FIG. 3A is a perspective view of a grooved structure in accordance with an illustrative embodiment;

FIG. 3B is a cross-sectional view of a channel polariton confined within the vicinity of a grooved structure in accordance with an illustrative embodiment;

FIG. 3C is a cross-sectional view of a channel polariton confined within the vicinity of a grooved structure in accordance with another illustrative embodiment;

FIG. 4 is an electron micrograph of a light emitting device in accordance with an illustrative embodiment;

FIG. 5A is a side view of a simulated light emitting device in accordance with an illustrative embodiment;

FIG. 5B is a side view of the simulated light emitting device of FIG. 5A;

FIG. 5C is a side view of a simulated light emitting device in accordance with another illustrative embodiment;

FIG. 5D is a side view of a simulated light emitting device;

FIG. 6 is a graph of far-field intensity profiles of various light emitting devices;

FIG. 7A is a simulated two-dimensional far-field intensity distribution of electromagnetic radiation emitted from a light emitting device;

FIG. 7B is a measured two-dimensional far-field intensity distribution of electromagnetic radiation emitted from another light emitting device in accordance with an illustrative embodiment;

FIG. 7C is a simulated two-dimensional far-field intensity distribution of electromagnetic radiation emitted from a different light emitting device;

FIG. 7D depicts a graph of line scans of the far-field intensity distributions of FIGS. 7B and 7C;

FIG. 8 is a graph of power output from various light emitting devices in accordance with an illustrative embodiment;

FIG. 9A is a simulated two-dimensional near-field intensity distribution of electromagnetic radiation of a light emitting device;

FIG. 9B is a simulated two-dimensional far-field intensity distribution of electromagnetic radiation of the light emitting device of FIG. 9A;

FIG. 10A is a simulated two-dimensional near-field intensity distribution of electromagnetic radiation of a different light emitting device; and

FIG. 10B is a simulated two-dimensional far-field intensity distribution of electromagnetic radiation of the light emitting device of FIG. 10A.

### DETAILED DESCRIPTION

Following below are more detailed descriptions of various concepts related to, and embodiments of, inventive methods and apparatus according to the present disclosure for engineering of electromagnetic radiation. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Aspects discussed herein relate to methods and apparatuses that may provide for the engineering of electromagnetic radiation emissions at mid-infrared and/or far-infrared wavelengths. In some embodiments, emissions of electromagnetic radiation at mid-infrared and/or far-infrared wavelength ranges exhibit a low divergence angle (e.g., less than 15 degrees). A light emitting device (e.g., laser device) including a collimating element having at least one indented region may be disposed adjacent to a laser waveguide. In some embodiments, and without limitation, the collimating element and the laser waveguide may both be fabricated on the same substrate so as to result in a single monolith device. A portion of the emitted electromagnetic radiation is coupled into surface waves propagating on the surface of the collimating element, which scatter the energy of the surface waves into the free space as a collimated beam. In some embodiments, indented regions of the collimating element may be formed as grooved structures that may slow down the velocity of electromagnetic radiation propagating along the surface of the collimating element and may substantially confine electromagnetic radiation within the grooved structures.

Spatial structures fabricated in conjunction with a laser waveguide on a laser device may provide for electromagnetic radiation emitted from the laser waveguide to be suitably tailored. In some embodiments, incorporation of certain spatial structures (e.g., two dimensional plasmonic metamaterials) with a laser waveguide (e.g., QCLs or other appropriate laser) on a laser device may enable those skilled in the art to suitably tailor the dispersion of electromagnetic radiation emitted from the laser waveguide. For example, upon emission of light from a laser waveguide, the structure of a collimating element disposed adjacent to the laser waveguide may induce a desired level of dispersion of the radiation (e.g., surface plasmons and/or channel polaritons) in the electromagnetic beam originated from the laser waveguide.

In some embodiments, the performance of such laser waveguides having a collimating element disposed adjacent thereto (e.g., on the same chip) may be suitably enhanced. In some cases, the divergence angle of a beam of light emitted from a laser waveguide may substantially improve when the laser waveguide is disposed adjacent to a suitably structured collimating element. For example, the divergence angle of a beam of light emitted from a laser waveguide absent the collimating element may be about 180 degrees; however, when including a suitably structured collimating element adjacent to the laser waveguide, the divergence angle of a beam of light may be less than 15 degrees (e.g., 10 degrees, 5 degrees). Similarly, the directivity of such laser systems including a suitably structured collimating element may exhibit an improvement of over 10 dB as compared to laser systems absent the collimating element. In some instances, the power collection efficiency may also improve by a factor of about 4 to 6 for laser systems including the structured collimating element, as opposed to such systems without the collimating element.

Embodiments described herein may be utilized in conjunction with a suitable laser. In some embodiments, the laser may contain a laser waveguide fabricated from semiconductor materials. In some embodiments, the laser may emit electromagnetic radiation having a mid-infrared wavelength (e.g., a wavelength between about 3 microns and about 50 microns) and/or a far-infrared wavelength (e.g., a wavelength between about 50 microns and about 500 microns). The latter corresponds to the terahertz (THz) frequency range. A QCL operating in the mid-infrared or far-infrared region may be used for sensing and analyzing of chemical and biological agents, as many gas- and liquid-phase chemicals have characteristic absorption features in these wavelength regions. Thus, detecting systems incorporating QCLs may be used to identify such chemical or biological agents. Some exemplary applications of QCLs in chemical sensing include medical diagnostics(such as breath analysis), pollution monitoring, environmental sensing of the greenhouse gases responsible for global warming, and remote detection of toxic chemicals and explosives. Examples of suitable QCLs that may be used in conjunction with the embodiments disclosed herein may be described in International Patent Application No. PCT/US11/30164, filed on Mar. 28, 2011, entitled “Quantum Cascade Laser Source with Ultrabroadband Spectral Coverage”; U.S. Pat. No. 5,936,989, filed on Apr. 29, 1997, entitled “Quantum Cascade Laser”; U.S. Pat. No. 6,137,817, filed on Jun. 12, 1998, entitled “Quantum Cascade Laser”; U.S. Pat. No. 6,690,699, filed on Feb. 21, 2002, entitled “Quantum Cascade Laser with Relaxation-Stabilized Injection”; and U.S. Patent Application Publication No. 2009/0213890, filed on Feb. 27, 2009, entitled “Quantum Cascade Laser.”

In some embodiments, suitable lasers may emit electromagnetic radiation that has a wavelength outside of the mid-infrared wavelength and far-infrared wavelength regions.

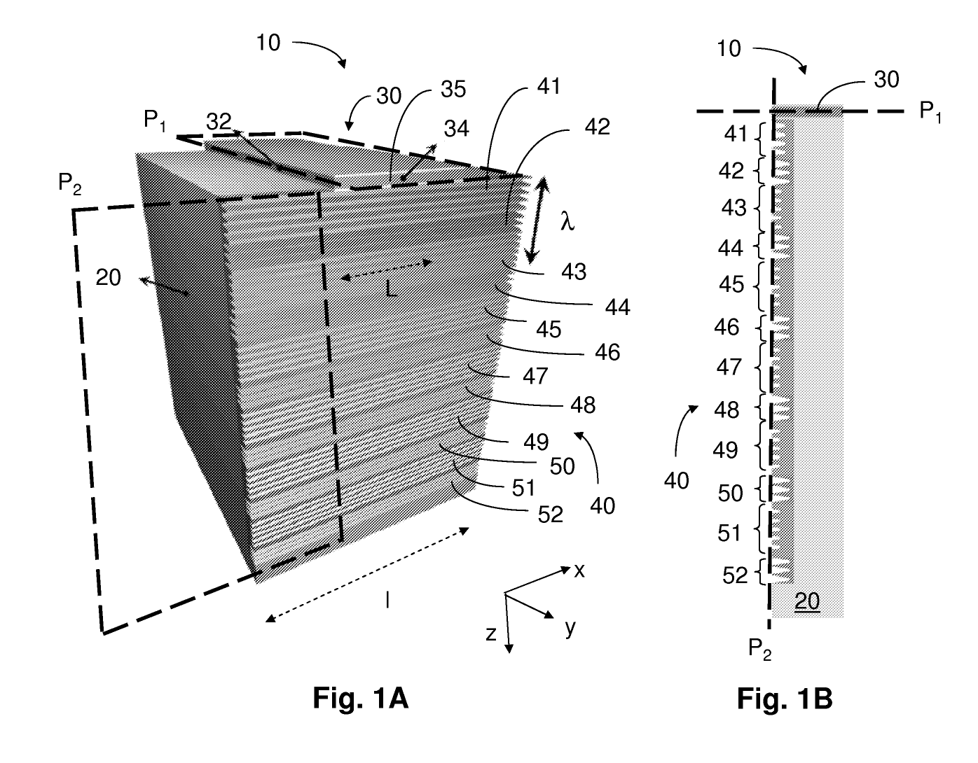

FIGS. 1A and 1B depict an illustrative embodiment of a light emitting device 10 having a substrate 20 with a laser 30 and a collimating element 40 disposed on the substrate. The laser includes a laser waveguide 32 and a laser aperture 34 having an end facet 35 from which electromagnetic radiation may be emitted. As illustrated, the laser waveguide may be disposed along a plane P₁, in parallel with the x-y plane. The collimating element 40 includes a plurality of indented regions that may be grouped into indentation clusters 41, 42, 43, 44, 45, 46, 47, 48, 49, 50, 51, 52. The indented regions of the collimating element may be disposed along a plane P₂, in parallel with the x-z plane. The end facet 35 of the laser aperture and the collimating element 40 may be disposed, without limitation, in coplanar relation along plane P₁, in parallel with the x-y plane.

As illustrated, the indented regions may be fabricated as grooved structures which include certain dimensions, such as the depth of the grooved structure, the width of the grooved structure at various points along the depth, and the distance between neighboring grooved structures. The indented regions may also be fabricated as a two dimensional array of holes. Indentation clusters may include indented regions having similar structural dimensions. Grooved structures may include substantially straight grooves having a longitudinal direction L that generally runs parallel to direction x, and having a length l. As shown, the grooved structures depicted in FIG. 1A are oriented along a longitudinal direction L that is parallel to the plane P₁ of the laser waveguide and a longitudinal direction of an end facet of the laser waveguide. In some embodiments, grooved structures may be able to substantially confine electromagnetic radiation propagating in a direction perpendicular and/or parallel to the longitudinal direction L of the grooved structure. In some embodiments, indented regions and/or grooved structures of a collimating element are not oriented in a longitudinal direction that is parallel to the plane of the laser waveguide. Other arrangements and structures are possible, as indented regions of a collimating element may be structured and disposed according to any suitable configuration.

In some embodiments, a plane P₁ of the laser waveguide and a plane P₂ of the collimating element are disposed perpendicular with respect to one another. However, in other embodiments not shown, the plane P₁ of the laser waveguide and the plane P₂ of the collimating element are disposed parallel with respect to one another.

Laser devices described herein may be formed with any suitable material. In some embodiments, laser devices may include any appropriate metal or conductive material, gallium arsenide, silicon, indium phosphide, any other suitable material, and/or combinations thereof. Such materials may exhibit optically metallic properties (i.e., electrically conductive and optically opaque) with respect to electromagnetic radiation in mid-infrared and/or far-infrared wavelength regions.

During operation of the light emitting device 10 of FIGS. 1A and 1B, a beam of electromagnetic radiation originates from the laser waveguide and exits the laser aperture. The laser may emit electromagnetic radiation having a long wavelength λ (e.g., mid-infrared or far-infrared). Thus, the distance of a single wavelength λ may span a number of indented regions (e.g., 5-15 indented regions) and indentation clusters (e.g., 2-4 indentation clusters).

Certain portions of the electromagnetic radiation may exit from the laser aperture and travel in various directions x, y, z. While a portion of the electromagnetic radiation may travel out from the light emitting device in a direction y, other portions of the electromagnetic radiation may propagate along the surface of collimating element 40 in directions z, x, along plane P₂ of the collimating element. The portion of electromagnetic radiation originating from the laser waveguide that propagates along direction z travels substantially perpendicular to the longitudinal direction L and plane P₁ of the laser waveguide. And the portion of electromagnetic radiation originating from the laser waveguide propagating along the positive and negative direction x travels substantially parallel to the longitudinal direction L and plane P₁ of the laser waveguide.

In some embodiments, the laser waveguide emits a beam of electromagnetic radiation that is polarized in a direction that is substantially parallel to the z-axis (i.e., vertically polarized, perpendicular to the plane P₁ of the laser waveguide).

In some cases, and without limitation, the electric field of an electromagnetic wave emitting from the laser waveguide has a polarization that matches the polarization of the surface waves propagating on the collimating element. Therefore, a portion of the electromagnetic wave will be coupled into surface waves propagating on the collimating element. The surface waves may be surface plasmons, which are coherent electron oscillations coupled with surface electromagnetic waves that exist at an interface between a metallic material and an insulating material. In various instances, surface plasmons may propagate along the surface of a material (e.g., metal, semiconductor) until the energy of the surface plasmons is fully dissipated (e.g., via absorption by the material or radiation away from the material).

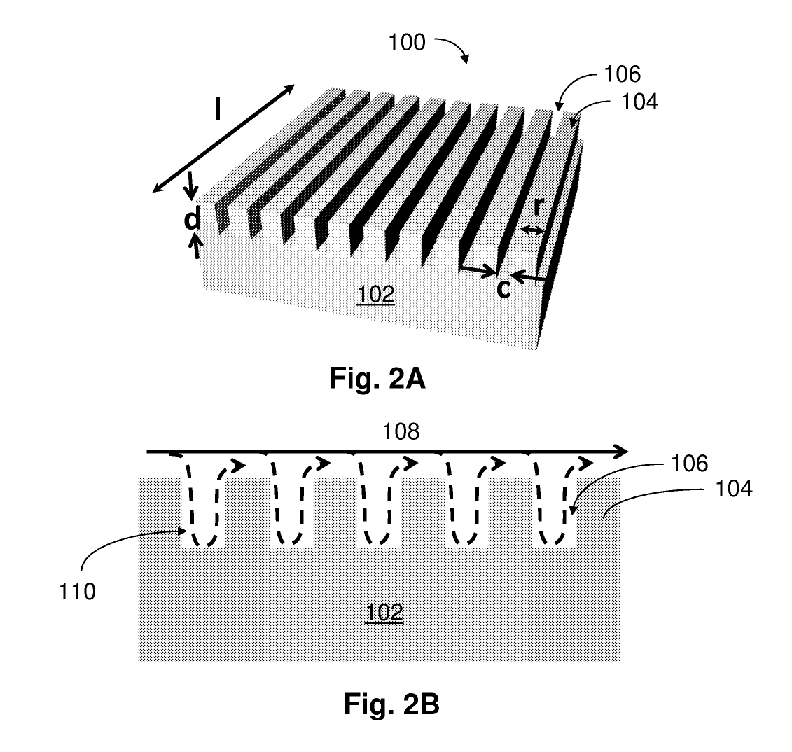

FIGS. 2A and 2B illustrate an embodiment of a collimating element 100 having a substrate 102, ridges 104, and indented regions 106. The indented regions may be formed as grooved structures each having a corresponding depth d and width c, and the ridges may each have a corresponding width r. The grooved structures may also have a length l. FIG. 2B depicts a schematic example of the effect that such grooved structures may have on surface electromagnetic waves 108 that propagate along the surface of a collimating element. In some embodiments, surface electromagnetic waves may be coupled to various resonant modes of the grooved structures, resulting in the controlled confinement of certain portions 110 of the surface electromagnetic waves (e.g., surface plasmon). Such controlled confinement in the vicinity of the grooved structures may result in controlled decrease in the velocity of the surface waves: the region with deeper grooves may correspond to a slower velocity, or a larger propagation constant. If the groove depths are arranged in a periodic way as shown in FIG. 1B, the propagation constant or the effective mode index of surface waves may be periodically modulated. As a result, the energy of the surface waves will be partially scattered into the free space at each period, leading to a series of scattered waves. These scattered waves constructively interfere, giving rise to a collimated beam with a low divergence angle.

The effective mode index n_{eff} of electromagnetic wave propagation, defined by c/v (where c=speed of light, and v=velocity of wave propagation) can effectively be controlled by tuning the dimensions of the indented regions. In some embodiments, the structure of indented regions in the collimating element may be configured to have dimensions such that the effective mode index of the system may be between about 1 and about 10, between about 1 and about 5, between about 1 and about 2, between about 1.1 and about 1.5, or between about 1.1 and about 1.3. As a result, indented regions of a collimating element may have any suitable structure and set of dimensions.

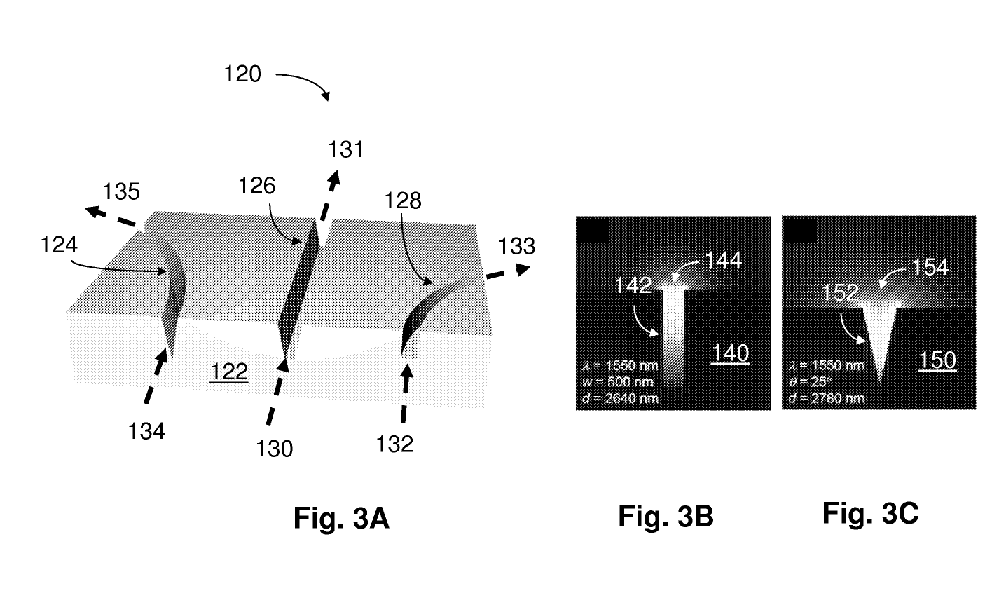

FIG. 3A depicts an illustrative embodiment of a group of grooved structures 120 that may be incorporated in a suitable collimating element. The grooved structures 124, 126, 128 are formed in a substrate 122. In some embodiments, portions of electromagnetic radiation (e.g., channel polaritons) may be substantially confined to grooved structures of a collimating element. For example, electromagnetic waves may enter into grooved structures via inlet passages 130, 132, 134 and exit from the grooved structures via respective outlet passages 131, 133, 135. In some embodiments, grooved structures may be formed into metallic surfaces through any suitable method. In some embodiments, the grooved structures may be suitable to substantially confine channel polaritons derived from the emitted electromagnetic radiation of the laser waveguide so that the channel polaritons propagate along the grooves.

Channel polaritons, in general, are electromagnetic waves confined in the vicinity of a channel and propagate along the channel FIGS. 3B and 3C show respective ridges 140, 150 and indented regions 142, 152 having a vicinity within which channel polaritons 144, 154 may be confined and propagate.

Indented regions of a collimating element may include any suitable structure and dimensions. In some embodiments, the collimating element may include structures that have dimensions that are subwavelength in nature as compared to the wavelength of light traveling along the collimating element and emitted from a laser waveguide. As described, indented regions may be formed as substantially straight grooved structures. In some embodiments, indented regions are not formed as grooved structures. In other embodiments, indented regions are not formed to be substantially straight. In some cases, indented regions may be formed as holes or gaps within the collimating element. Such holes or gaps within the collimating element may have any suitable geometry, for example, in accordance with the geometry of a grooved structure.

Indented regions of a collimating element may have any appropriate depth. In some embodiments, the depth d of at least one indented region of a collimating element may range between about 10 nanometers and about 150 microns, between about 0.1 micron and about 150 microns, between about 1 micron about and about 50 microns, between about 1 micron about and about 20 microns, between about 5 microns about and about 20 microns, or between about 5 microns and about 10 microns. In some embodiments, the depth d of at least one indented region of a collimating element may be designed to correspond to a fraction of a wavelength of emitted light from the laser. For example, the depth d of a indented region of a collimating element may range between about 0.01 and about 1, between about 0.05 and about 0.5, between about 0.05 and about 1, or between about 0.1 and about 0.25 times of a wavelength of the emitted beam of electromagnetic radiation. In some cases, the depth of a first indented region disposed along the collimating element may be greater than a second indented region disposed along the collimating element, where the first indented region is closer to the laser waveguide than the second indented region.

The collimating element may include indented regions having any suitable width at various depths of the indented region. In some embodiments, the width c of at least one indented region of a collimating element at any particular depth may range between about 10 nanometers and about 150 microns, between about 0.1 micron and about 150 microns, between about 0.5 microns about and about 20 microns, between about 0.5 microns and about 15 microns, or between about 1 micron and about 10 microns. In some embodiments, the width c of a indented region of a collimating element may be a fraction of a wavelength of emitted light from the laser. For example, the width c of at least one indented region of a collimating element at a particular depth may range between about 0.001 and about 0.5, between about 0.01 and about 0.5, or between about 0.05 and about 0.2 times of a wavelength of the emitted beam of electromagnetic radiation. As discussed, the width of an indented region may vary along the depth of the indented region. In some embodiments, an upper width of an indented region at the top of the indented region (e.g., at the opening of a groove) may be greater than a lower width at the bottom of the indented region (e.g., at the base of a groove). For example, due to the nature of focused ion beam milling, indented regions may exhibit a trapezoidal cross-sectional shape. Any suitable method may be used to form indented regions and grooved structures of a collimating element.

The collimating element may include suitable ridges that separate neighboring indented regions. In some embodiments, the distance r between neighboring edges of two indented regions separated by a ridge may range between about 10 nanometers and about 150 microns, between about 0.1 micron and about 150 microns, between about 0.5 microns and about 50 microns, between about 1 micron and about 10 microns, or between about 5 microns and about 10 microns. In some embodiments, the distance r between neighboring edges of two indented regions separated by a ridge may be characterized as a fraction of the wavelength of emitted light from the laser. For example, the distance r between neighboring edges of two indented regions may range between about 0.01 and about 1, between about 0.01 and about 0.5, between about 0.01 and about 0.1, or between about 0.05 and about 0.2 times of a wavelength of the emitted beam of electromagnetic radiation.

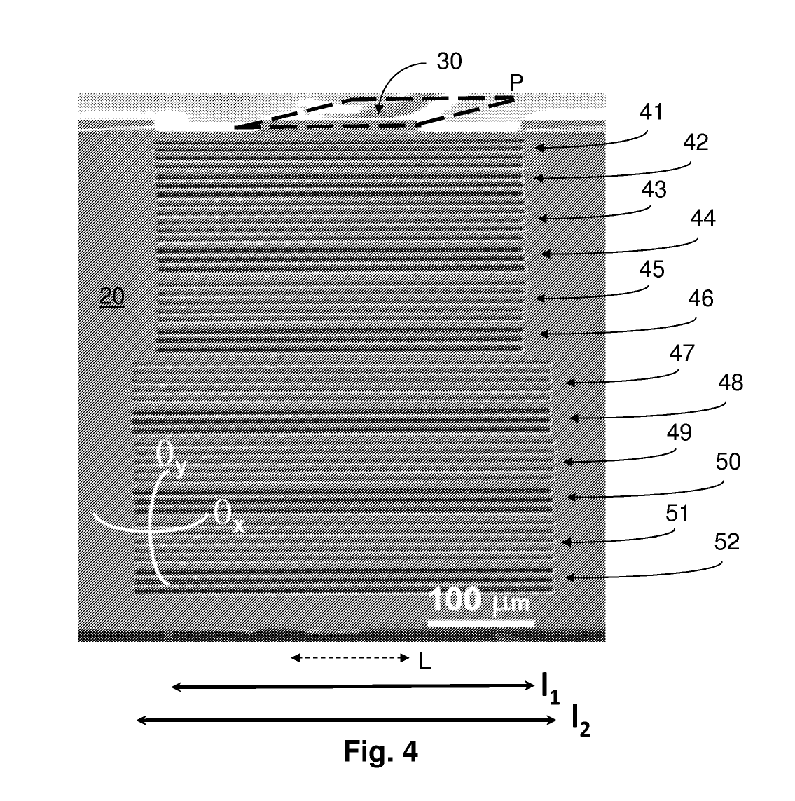

The length of a grooved structure along a longitudinal direction within a collimating element may be any suitable distance. In some embodiments, the length of a grooved structure along a collimating element may range between about 10 microns and about 10 mm, between about 50 microns and about 10 mm, between about 100 microns about 1 mm, between about 100 microns and about 800 microns, between about 200 microns and about 800 microns, between about 300 microns and about 600 microns, or between about 400 microns and about 500 microns. In some embodiments, the length of a grooved structure along a collimating element may be characterized as a multiple of wavelengths of emitted light from the laser. For example, the length of a grooved structure along a collimating element may be between about 0.5 and about 100, between about 1 and about 10, between about 3 and about 7, or between about 4 and about 5 times of the wavelength of the electromagnetic radiation emitted from the laser. In some embodiments, the length of the grooved structures of a collimating element may be larger than the width of the laser waveguide itself. In some cases, and without limitation, grooved structures of a collimating element disposed closer to a laser than other grooved structures of the collimating element may have a length in a longitudinal direction (e.g., a horizontal length) that is less than that of the other grooved structures of the collimating element. For example, as shown in FIG. 4, grooved structures of indentation clusters 41, 42, 43, 44, 45, 46 disposed closer to the laser 30 than grooved structures of other indentation clusters 47, 48, 49, 50, 51, 52 have a length l₁ along the longitudinal direction L that is less than the length l₂ of the grooved structures of indentation clusters 47, 48, 49, 50, 51, 52.

As discussed, the collimating element may incorporate any suitable set of structures and dimensions. In some embodiments, a number of indented regions of the collimating element having similar structure and dimensions may be disposed in a periodic arrangement. In some embodiments, indented regions and/or grooved structures may be grouped into clusters of grooved structures and/or indented regions having similar dimensions. Further, clusters of grooved structures and/or indented regions may also be disposed in a periodic arrangement. For example, a number of indented regions may have a depth that is spaced periodically along a surface of the collimating element. In some cases, indented regions are grouped into indentation clusters where each cluster may have a different depth and the clusters may be spaced periodically along the surface of the collimating element. In some embodiments, indentation clusters may be arranged such that indented regions having different depths alternate with respect to one another.

Laser systems presented herein provide advantages over existing lasers that emit beams of electromagnetic radiation in a mid-infrared and/or far-infrared wavelength regime. For example, systems described may provide improvements over conventional lasers, such as, with respect to the divergence angle of the electromagnetic beam, power output, and directivity.

Embodiments of laser devices may emit electromagnetic radiation having a mid-infrared and/or far-infrared wavelength that has an improved divergence angle over existing laser systems. In some embodiments, laser waveguides may emit a beam of electromagnetic radiation having a mid-infrared and/or far-infrared wavelength where the divergence angle of the beam as measured by methods known in the art is less than 15 degrees, less than 10 degrees, less than 5 degrees, less than 3 degrees, or about 1 degree. In various embodiments, having a collimating element with at least one indented region disposed adjacent to the laser improves divergence angle of a beam of electromagnetic radiation emitted from the laser from about 180 degrees (without the collimating element having one or more indented regions) to less than 15 degrees (incorporating the collimating element having one or more indented regions). The divergence angle of a beam of electromagnetic radiation may be measured according to any suitable method known in the art. In some embodiments, the divergence angle of the beam of electromagnetic radiation is assessed by measuring the full-width at half-maximum of the far-field intensity profile.

Laser devices described herein may emit electromagnetic radiation having a mid-infrared to far-infrared wavelength in a manner where inclusion of the collimating element improves the power output of the laser device. In some embodiments, inclusion of a suitably structured collimating element having at least one indented region adjacent to a laser waveguide improves the peak power output of the laser beam as compared with emission of the laser beam absent the collimating element by a range of between about 100% and about 1,000%, between about 200% and about 800%, between about 400% and about 600%, or between about 500% and about 600%. The power output of a beam of electromagnetic radiation may be measured according to any suitable method known in the art.

The collimating element may also improve the directivity of the beam of electromagnetic radiation having a mid-infrared to far-infrared wavelength. Directivity D may be used to help characterize collimation of electromagnetic radiation for laser devices described herein and may be defined as D=10 log₁₀(2πIₚₑₐₖ/Iₜₒₜₐₗ), where Iₚₑₐₖ is the far-field peak intensity and Iₜₒₜₐₗ is the total intensity under the beam profile. In some embodiments, inclusion of suitably structured collimating element having at least one dent ed region adjacent to the laser waveguide improves the directivity of the laser beam as compared with emission of the laser beam absent the collimating element by a range of between about 1 dB and about 50 dB, between about 1 dB and about 30 dB, between about 3 dB and about 20 dB, between about 5 dB and about 15 dB, or between about 8 dB and about 12 dB.

Laser devices including both a laser waveguide and a collimating element built in thereto may be manufactured according to any suitable method. In some embodiments, a laser (e.g., QCL) may be grown (e.g., by molecular beam epitaxy, metalorganic vapour phase epitaxy) on a suitable substrate (e.g., undoped or highly-doped GaAs). In some cases, a laser may be formed via a series of appropriate etch and wafer-bonding steps. In forming the collimating element, suitable patterns may be etched into the substrate, for example, using focused ion beam milling or imprint lithography.

As described herein, forming a collimating element with a laser waveguide in a manner that results in a single monolithic device may afford a number of advantages. For example, use of a separate collimating lens (e.g., micro-silicon lens) would not be required for electromagnetic radiation to be suitably collimated. Accordingly, the conventionally required alignment step when using a collimating lens in conjunction with a laser device (which is usually a meticulous alignment process), for embodiments described herein, is no longer needed. In some cases, however, a separate collimating lens could still be used in accordance with the laser system. The single monolithic device also leads to a generally more robust and durable system.

Laser devices described herein may include any number of laser waveguides and collimating elements. For example, a laser device may include a single collimating element and a plurality of laser waveguides; or a single laser waveguide and a plurality of collimating elements. In addition, embodiments of laser devices may include one or more laser waveguides disposed adjacent to one or more collimating elements in any suitable arrangement. For example, as shown in FIG. 1A, a collimating element may be disposed below a laser waveguide where a plane P₂ of the collimating element is perpendicular to a plane P₁ of the laser waveguide. In another example (not shown), a laser waveguide may be disposed between two collimating elements above and below, or to the side of, the laser waveguide. In some embodiments, a laser device may include a suitable array of laser waveguides and/or collimating elements.

In some aspects, the ability to confine low-frequency surface waves to subwavelength scales may lead to more efficient manipulation and stronger interaction of electromagnetic waves with analytes on a surface. In addition, the ability to engineer dispersion properties of surface plasmons may facilitate optical impedance matching between different components, and may lead to other optical elements for beam engineering of infrared radiation.

Laser devices described herein may be used for a variety of suitable applications. In some cases, devices incorporating a QCL and a built-in collimating element adjacent to the QCL may be useful for chemical sensing, imaging, heterodyne chemical detection, wavefront engineering, optical detection, slow light, and photovoltaics applications. For example, a mid-infrared or far-infrared laser waveguide emitting a collimated electromagnetic beam may serve to illuminate biological chemicals having a particular absorption spectrum. Such applications may be used in areas such as astronomy (e.g., identifying particles in space), clean energy (e.g., detecting gas/pollution concentration levels), and medicine (e.g., to aid a diagnosis) as well. Laser systems may also be useful for military countermeasures, such as in re-directing heat-seeking missiles to alternative locations.

As described herein, using doped semiconductors as media for engineering metamaterials, such as grooved structure indented regions, may provide for laser devices having tunable and reconfigurable functions. As such, the optical properties of such laser devices may be tunable by controlling the free-charge density of the device by any suitable optical or electrical method.

### EXAMPLE

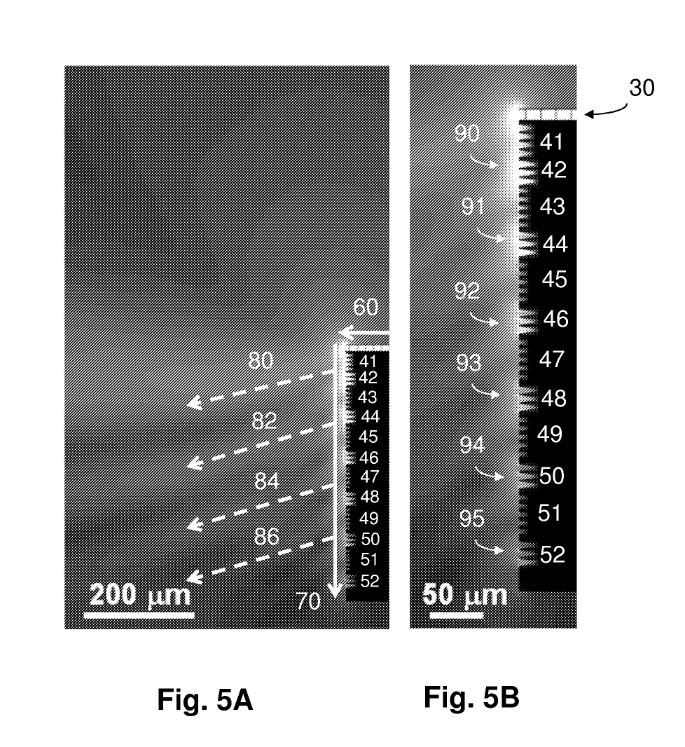

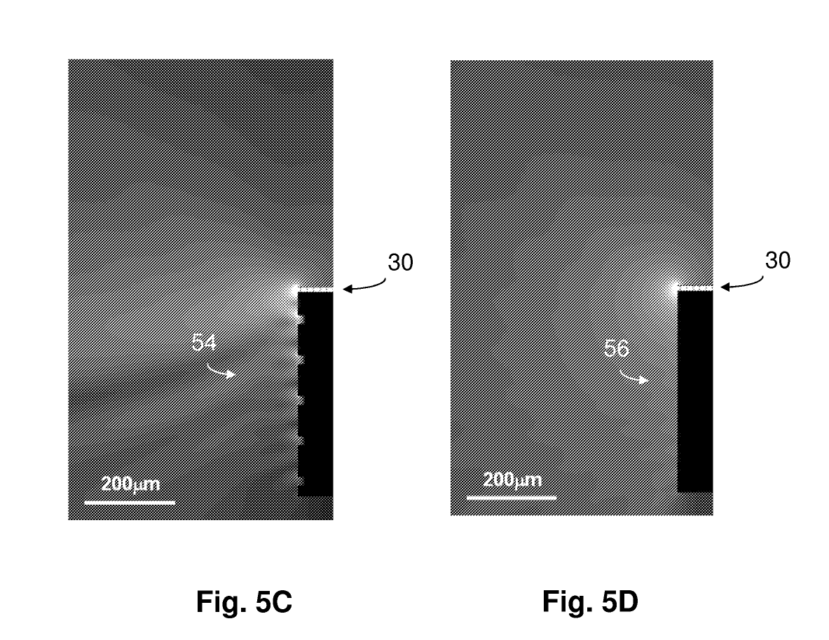

A non-limiting example of a laser device incorporating both a laser waveguide and collimating element into a single monolith is illustrated in FIG. 4. FIG. 4 shows an electron micrograph of an experimental laser device having a collimating element. The collimating element occupies a small footprint spanning dimensions of about 4λ×4.5λ. FIGS. 1A, 1B, 5A, and 5B also show simulations of the laser device. This example involves a 3 THz (ζₒ=100 μm) QCL which includes a double-metal waveguide provided on a 450-μm-thick highly-doped GaAs substrate. Grooved structures of indentation clusters 41, 42, 43, 44, 45, 46, 47, 48, 49, 50, 51, 52 are shown below in Table 1.

TABLE 1
Dimensions of grooved structures of the collimating element of FIG. 4.

| | Opening | | | Distance |
|---|---|---|---|---|
| | width | Bottom width | Depth | between grooves |
| | (microns) | (microns) | (microns) | (microns) |
| Indentation | 2.5 | 6.5 | 12 | 8 |
| cluster 41 | | | | |
| Indentation | 2 | 7 | 16 | 8 |
| cluster 42 | | | | |
| Indentation | 2 | 4 | 8.5 | 8 |
| cluster 43 | | | | |
| Indentation | 2 | 7 | 16 | 8 |
| cluster 44 | | | | |
| Indentation | 2 | 4 | 7 | 8 |
| cluster 45 | | | | |
| Indentation | 2 | 7 | 16 | 8 |
| cluster 46 | | | | |
| Indentation | 2 | 4 | 7 | 8 |
| cluster 47 | | | | |
| Indentation | 2 | 7 | 16 | 8 |
| cluster 48 | | | | |
| Indentation | 2 | 4 | 7 | 8 |
| cluster 49 | | | | |
| Indentation | 2 | 7 | 16 | 8 |
| cluster 50 | | | | |
| Indentation | 2 | 4 | 7 | 8 |
| cluster 51 | | | | |
| Indentation | 2 | 7 | 16 | 8 |
| cluster 52 | | | | |

Accordingly, grooved structures of indentation cluster 41 and indentation cluster 43 have unique dimensions. Grooved structures of indentation clusters 42, 44, 46, 48, 50, 52 are part of a group of channels having similar dimensions (generally deep grooves). Grooved structures of indentation clusters 45, 47, 49, 51 are part of another group of grooves that have similar dimensions (generally shallow grooves). Indentation clusters 42, 44, 46, 48, 50, 52 and indentation clusters 45, 47, 49, 51 are also spaced apart in a periodic relation.

In this example, grooved structures are formed directly on a GaAs substrate without a metal coating in a manner that allows for tailoring of surface plasmon dispersion. As such, a metal coating is not required as the carrier concentration in highly doped semiconductors is sufficiently large such that the semiconductor exhibits conductive properties and where the real part of the dielectric permittivity generally takes on large negative values.

The QCL material was grown by molecular beam epitaxy on an undoped GaAs substrate. The growth sequence started with a 250-nm-thick undoped GaAs buffer layer, and was followed by a 300-nm-thick Al_{0.5}Ga_{0.5}As etch-stop layer, a 75-nm-thick layer of GaAs n-doped to 5×10¹⁸ cm⁻³, the active region, and finally a 50-nm-thick GaAs layer n-doped to 5×10¹⁸ cm⁻³. The active region included 170 periods of a two-phonon resonance active region design, with a doping sheet density of nₛ=3.65×10¹⁰ cm⁻². The material was processed into copper metal-metal waveguides. First, a square centimeter of QCL material was cleaved and sputter coated with Ta/Cu/Au (15/500/500 nm). The material was then wafer-bonded to a highly-doped (1.6×10¹⁸ cm⁻³) GaAs substrate coated with sputtered layers of Ti/Au (15/500 nm). The bonded QCL wafer was next polished and wet-etched down to the etch-stop layer with a hydrogen peroxide/ammonium hydroxide solution (19:1 in volume), and the etch stop layer was stripped with concentrated hydrofluoric acid. The laser ridges, with widths ranging from 25 to 150 μm, were then defined using dry etching with a SU-8 2005 photoresist mask. After SU-8 removal, metal (Ta/Cu/Au, 15/100/30 nm) was sputtered on top of the laser ridges. A gold capping layer was added to the waveguides with copper cladding to avoid copper oxidation and to facilitate wire bonding. The processed wafers were finally cleaved into 1 to 2-mm-long bars and indium-mounted onto copper blocks.

The back facets of the QCLs were coated with 300-nm Al₂O₃ and 100-nm gold so that the measured far-field profiles were solely due to emission from the front facets. To suppress higher-order transverse modes in the wide-ridge devices, side-absorbers were defined by removing ˜3 to 4-μm-wide strips of metal along the edges of the device top contact. Devices fabricated in this way have maximum operating temperatures ˜10 to 20 degrees lower compared with devices without side-absorbers.

Plasmonic metamaterial patterns were etched into the substrate using focused ion beam milling (Zeiss NVision 40) at a high current of 13 or 27 nA to limit fabrication time. The diameter of the Ga ion beam at this current was ˜1 μm, giving rise to a trapezoidal cross-section of the fabricated grooves.

At the aperture of the double metal waveguide, the laser emits both directly into the far-field and also into surface waves on the laser device. In this example, the grooved structures of the collimating element are fabricated as spoof surface plasmon polariton modes disposed adjacent to the laser aperture which may increase the effective in-plane wavevector of surface plasmons, reducing wavevector mismatch. Accordingly, more light may be coupled out from the laser indented region with a large percentage of light being channeled into the grooved structures of the spoof surface plasmon polariton modes rather than being directly emitted into the far-field. Further, deep grooved structures of indentation clusters 42, 44, 46, 48, 50, 52 may periodically modulate the dispersion of surface plasmons on the collimating element, creating a second-order grating that scatters energy of the surface plasmons into the far-field. Constructive interference between these scattered waves and the direct emission from the laser aperture gives rise to a low-divergence angle beam normal to the grooved structure in the far-field. Shallow grooved structures of indentation clusters 45, 47, 49, 51 may increase overall confinement of surface plasmons, resulting in an improvement of the scattering efficiency of the second-order grating. This example demonstrates how grooved structures may be engineered to serve multiple functions; by engineering the dispersion of surface plasmons, such grooved structures may result in a collimating element that improves device power throughput, increases directivity, and decreases beam divergence angle.

As discussed above, the depth of the more shallow grooved structures of indentation clusters 45, 47, 49, 51 was within the range of 7-12 microns to provide sufficient confinement of surface plasmon polaritons without introducing large optical losses arising from optical absorption that occurs with increasing groove depth. The shallow grooved structures were constructed to have a smaller depth farther from the laser aperture resulting in an overall reduction of absorption loss. The surface plasmon phase velocity was measured to be variable (not constant), being smaller in regions closer to the laser aperture. Periods of the second-order grating were shorter in close vicinity to the laser aperture so that resulting scattered waves would be in phase so as to maximize constructive interference.

Simulations of the laser devices were obtained using Lumerical FDTD Solutions 6.0 running on the NNIN/c computational cluster operated by the School of Engineering and Applied Sciences (SEAS) at Harvard University. The grid size in and around the vicinity of the grooved structures was about 180 nm (˜λₒ/55) in the direction along the facet and perpendicular to the grooved structures, and about 140 nm (˜λₒ/70) in the direction perpendicular to the facet, to ensure that grooved structures of the spoof surface plasmon polaritons were well resolved. The grid size in the direction along the grooved structures was about 470 nm (˜λₒ/20). The source was the fundamental TM₀₀ waveguide mode launched 16 microns from the facet. The total running time was ˜10 hours on 64 cluster nodes. The 2D simulations based on finite-element method were performed using COMSOL Multiphysics 3.3 running on a personal computer.

FIG. 5A presents a simulated electric-field distribution of the laser device where an electromagnetic wave 60 originates from the laser waveguide 30. Surface electromagnetic waves 70 are scattered from the grooved structures of the spoof surface plasmon polariton collimating element into electromagnetic scatter waves 80, 82, 84, 86. As shown in FIG. 5B, surface plasmon polaritons 90, 91, 92, 93, 94, 95 can be seen substantially confined within an immediate vicinity of the grooved structures.

Simulated comparisons of electric field, intensity, and power output were made between a laser device incorporating indentation clusters shown in FIGS. 5A and 5B, a laser device having an indentation cluster 54 with indented regions having a single depth and periodicity, and a laser device without collimating indentation clusters 56 (i.e., without the collimating element). These simulations indicate that the power throughput of the laser device incorporating the spoof surface plasmon polariton collimating element is approximately 25% greater than the power throughput of a similar device 56 without the collimating element (see FIG. 5D). It is estimated that 44% of the laser output is coupled into the grooved structures of the spoof surface plasmon polariton collimating element while the remaining 56% is emitted into the far-field. A simulation with only the indentation cluster 54, shown in FIG. 5c, estimates the power coupled into surface waves to be merely 15%, while the remaining 85% is radiated directly into the far-field.

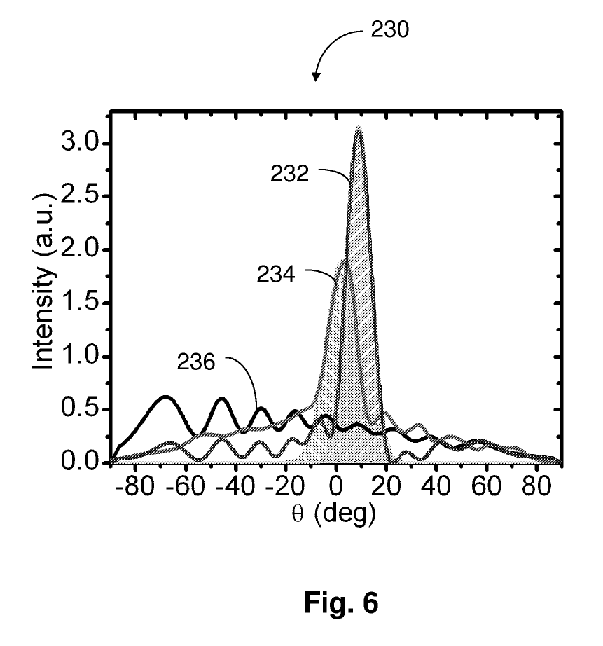

FIG. 6 depicts a graph 230 of the intensity distribution in the far-field of the laser device incorporating the grooved structures of the spoof surface plasmon polariton collimating element (shown in FIGS. 5A-5B) as compared with a similar laser waveguide adjacent to an indentation cluster 54 with indented regions having a single depth (shown in FIG. 5C), and the laser waveguide adjacent to a smooth structure 56 having no indented regions at all (shown in FIG. 5D). For the laser device incorporating the grooved structures of the spoof surface plasmon polariton collimating element, the intensity distribution 232 was estimated to result in a directivity of about 16 dB. For the laser device incorporating only the structure with an indentation cluster 54 including indented regions having a single depth and periodicity adjacent to the laser waveguide, the intensity distribution 234 was estimated to result in a directivity of about 10 dB. The intensity distribution 236 of the laser device not having grooved structures of any kind adjacent to the laser waveguide exhibits a directivity of about 5 dB.

Laser devices were tested in pulsed mode with 60 ns pulses at 0.3% duty cycle (60 ns pulses at a 100 kHz repetition rate, with an additional 1 kHz modulation at 50% duty cycle for lock-in detection). Laser powers were measured using a Fourier transform infrared (FTIR) spectrometer with a calibrated helium-cooled bolometer using two 2″-diameter parabolic mirrors; one with a 5-cm focal length to pass light from devices to the input of the FTIR spectrometer, and the other with a 15-cm focal length to focus the light from the output of the FTIR spectrometer onto the bolometer. To map the 2D far-field emission profile of the devices, a cryostat, in which the lasers were mounted vertically (laser material layers normal to the horizontal plane), was placed on a rotation stage. Line-scans of the laser far-field along the θ direction were obtained as the stage is rotated in the horizontal plane. The relative height of the cryostat and the bolometer was adjusted to allow many line-scans of the device far-field to be obtained, and finally construct into a 2D map. The 2D map was corrected considering: (1) the variation of distance between the device and the detection area of the bolometer; and (2) the variation of incidence angle of the THz radiation on the detector, as the relative height of the cryostat and the bolometer was changed.

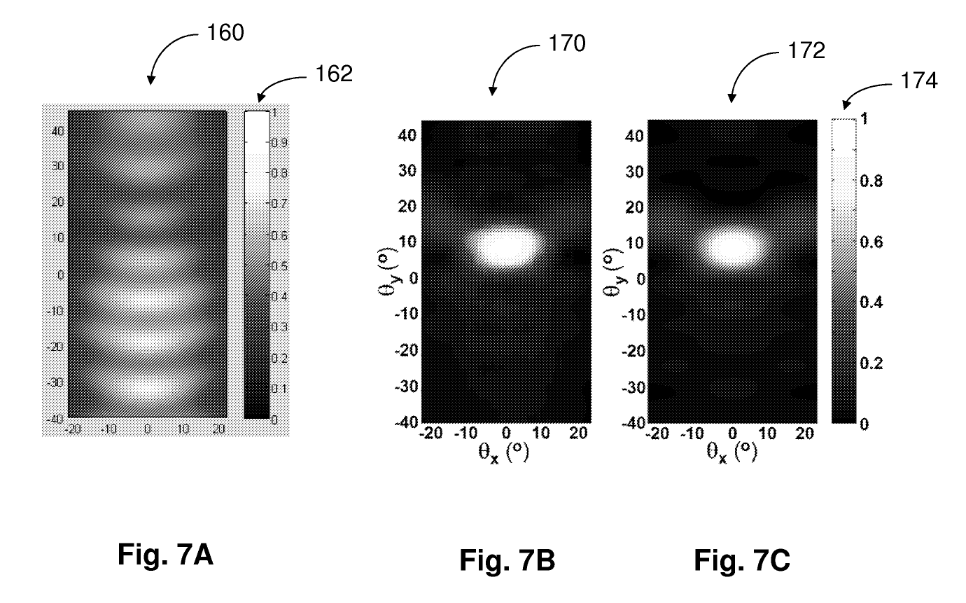

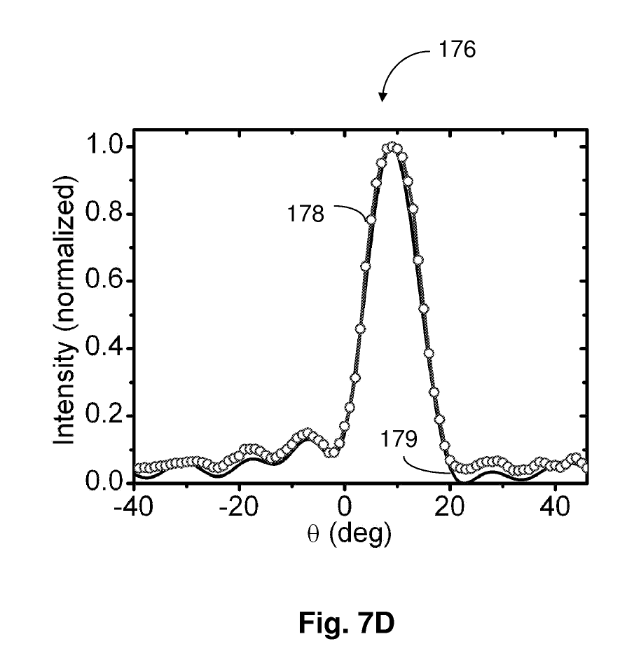

The 2D far-field intensity profile was measured and simulated for laser devices with and without the collimating element having spoof surface plasmon polariton grooved structures. FIG. 7A shows a measured 2D far-field intensity profile 160 (with an accompanying legend 162) of a beam of electromagnetic radiation generated from a laser device without a collimating element having indented regions or grooved structures, illustrating a substantial amount of far-field dispersion. Accordingly, the emission of electromagnetic radiation without the collimating element is highly divergent. FIGS. 7B and 7C depict a measured 2D far-field intensity profile 170 and a simulated 2D far-field intensity profile 172 (with an accompanying legend 174) of a beam of electromagnetic radiation generated from a laser device incorporating the grooved structures of the spoof surface plasmon polariton collimating element. FIG. 7D depicts a graph 176 of line scans 178, 179 of FIGS. 7B and 7C, respectively, along θₓ=0° in the vertical direction θ_{y}. The line scan 178 (with circles) illustrates the measured far-field intensity profile while the line scan 179 (solid line) illustrates the simulated far-field intensity profile. The vertical and lateral divergence angles of the electromagnetic radiation with the collimating element are ˜11.7° and ˜16°, respectively (full-width at half-maximum (FWHM)).

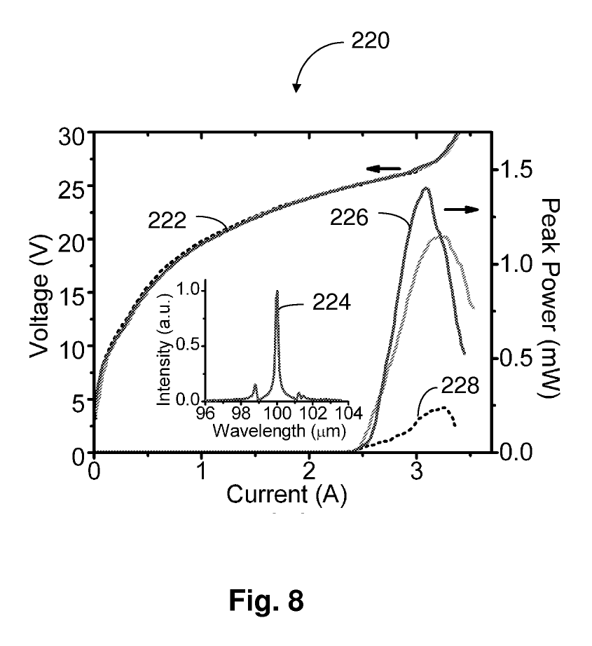

The collected power of the laser device having the grooved structures of the spoof surface plasmon polariton collimating element was observed to increase by a factor of ˜6 as compared to the collected power of a laser device without the collimating element under the same measurement conditions. For the laser device including an indentation cluster with only a single groove depth, the collected power enhancement is ˜5. FIG. 8 depicts a graph 220 of power output and voltage measured as a function of pump current for the laser device. The voltage behavior 222 was measured in relationship with the applied current for the laser device with and without the collimating element. The spectrum 224 of the laser device depicts the wavelength of the emitted electromagnetic radiation to be about 100 microns. The electromagnetic radiation generated from a laser device incorporating the collimating element with spoof surface plasmon polariton grooved structures exhibits a power output 226 that is several times greater than the power output 228 of a similar device without the collimating element.

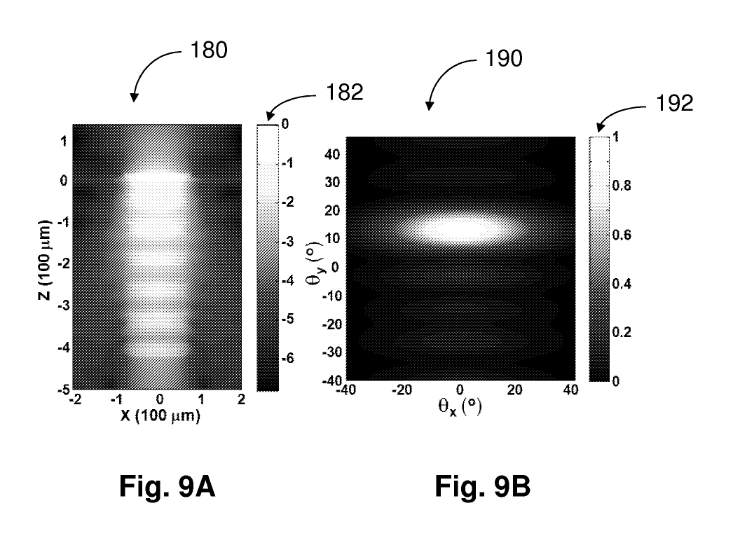

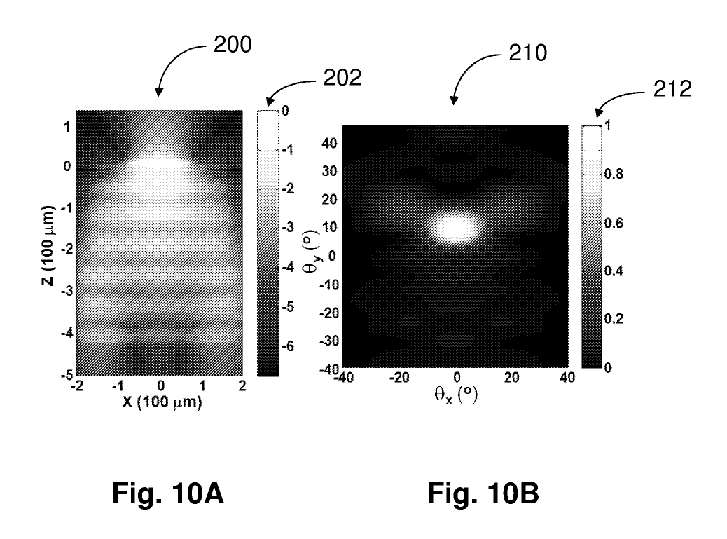

The effects of lateral spreading of surface electromagnetic waves due to the length of a collimating element with spoof surface plasmon polariton grooved structures disposed adjacent to a laser from which the waves are emitted are illustrated in FIGS. 9A-9B and 10A-10B. Generally, a wider lateral near-field distribution of electromagnetic waves is indicative of a narrower lateral far-field divergence angle of the electromagnetic waves. That is, the lateral near-field distribution of electromagnetic waves generally is inversely related to the lateral far-field distribution of electromagnetic waves.

FIGS. 9A and 9B show the simulation results of a near-field intensity profile 180 (with accompanying legend 182) and a far-field intensity profile 190 (with accompanying legend 192) of a beam of electromagnetic radiation emitted from a laser device having a collimating element with spoof surface plasmon polariton grooved structures 150 microns in length. Due to the limited space available for lateral spreading to occur, the electromagnetic beam of FIGS. 9A and 9B has experienced substantial lateral far-field divergence angle.

FIGS. 10A and 10B illustrate the simulation results of a near-field intensity profile 200 (with accompanying legend 202) and a far-field intensity profile 210 (with accompanying legend 212) of a electromagnetic beam generated from a laser device having a collimating element including spoof surface plasmon polariton grooved structures having a length of 400 microns. While the near-field intensity profile 200 shows increased lateral spreading of the channel polaritons, the far-field intensity profile 210 exhibits only a slight degree of lateral beam divergence angle in the far-field. In this example, the laser device having a collimating element with longer grooved structures is better adapted to accommodate the natural diffraction of light than the laser device having a collimating element with shorter grooved structures. Thus, the electromagnetic radiation arising from the device having longer grooved structures exhibits a minimally dispersed far-field intensity.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A laser device, comprising:
a substrate;
a laser waveguide disposed on the substrate and configured to emit electromagnetic radiation; and
a collimating element disposed adjacent to the laser waveguide and having at least one indented region.

2. The laser device of claim 1, wherein the laser waveguide comprises a quantum cascade laser.

3. (Canceled

4. The laser device of claim 1, wherein the at least one indented region of the collimating element comprises at least one grooved structure.

5. (canceled)

6. (canceled)

7. The laser device of claim 4, wherein the at least one grooved structure is oriented in a longitudinal direction that is parallel to a plane of the laser waveguide.

8. The laser device of claim 7, wherein the longitudinal direction of the at least one grooved structure is parallel to a longitudinal direction of an end facet of the laser waveguide.

9. The laser device of claim 4, wherein the at least one grooved structure is substantially straight.

10. The laser device of claim 4, wherein the at least one grooved structure comprises a first groove and a second groove, and wherein the first groove is disposed closer to the laser waveguide than the second groove and a length of the first groove along a longitudinal direction is less than a length of the second groove along the longitudinal direction.

11-16. (canceled)

17. The laser device of claim 1, wherein the at least one indented region comprises a first indented region and a second indented region, and wherein a distance between neighboring edges of the first indented region and the second indented region ranges between about 10 nanometers and about 150 microns.

18. (canceled)

19. The laser device of claim 1, wherein the at least one indented region comprises a first indented region and a second indented region, and wherein the first indented region is disposed closer to the laser waveguide than the second indented region and a depth of the first indented region is greater than a depth of the second indented region.

20-26. (canceled)

27. A method of operating a laser, comprising:
emitting a beam of electromagnetic radiation from a laser waveguide having a wavelength of between about 3 microns and about 500 microns and the beam of electromagnetic radiation exhibiting a divergence angle of less than 15 degrees, wherein a collimating element is attached to the laser waveguide.

28. The method of claim 27, wherein the beam of electromagnetic radiation is polarized in a direction substantially perpendicular to a plane of the laser waveguide.

29. The method of claim 27, wherein emitting a beam of electromagnetic radiation from the laser waveguide comprises propagating a portion of the radiation along a surface of a collimating element having at least one indented region.

30-32. (canceled)

33. The method of claim 29, wherein propagating a portion of the radiation along a surface of a collimating element comprises propagating surface plasmons in a direction perpendicular to a longitudinal direction of the at least one indented region of the collimating element.

34. (canceled)

35. The method of claim 33, wherein propagating surface plasmons comprises substantially confining the portion of radiation along the surface of the collimating element in a vicinity of the at least one indented region.

36. The method of claim 29, wherein propagating a portion of the radiation along a surface of a collimating element comprises propagating channel polaritons in a direction parallel to a longitudinal direction of the at least one indented region of the collimating element.

37. The method of claim 36, wherein propagating channel polaritons comprises substantially confining the portion of radiation along the surface of the collimating element in a vicinity of the at least one indented region.

38-45. (canceled)

46. A method of using a laser device to collimate electromagnetic radiation, comprising:
operating a laser waveguide disposed adjacent to a collimating element to emit electromagnetic radiation from the laser waveguide such that a portion of the radiation propagates along a surface of the collimating element and is scattered into free space to form a collimated beam that exhibits a divergence angle of less than 15 degrees.

47-52. (canceled)

53. The method of claim 46, wherein operating a laser waveguide to emit electromagnetic radiation such that a portion of the radiation propagates along a surface of the collimating element and is scattered into free space comprises emitting a collimated beam that exhibits a peak power between about 400% and about 600% greater than emission of the beam absent the collimating element.

54. The method of claim 46, wherein operating a laser waveguide to emit electromagnetic radiation such that a portion of the radiation propagates along a surface of the collimating element and is scattered into free space comprises emitting a collimated beam that exhibits a directivity between about 1 dB and about 50 dB greater than emission of the beam absent the collimating element.

55. The method of claim 46, wherein operating a laser waveguide to emit electromagnetic radiation comprises emitting electromagnetic radiation having a wavelength of between about 3 microns and about 500 microns.
